(19) United States
(12) Patent Application Publication
(10) Pub. No.: US 2006/0278511 A1
(43) Pub. Date: Dec. 14, 2006

(54) Switch of an actuating mechanism of a cart for use by elderly and handicapped persons

(76) Inventors: Hui-Pin Yang, Chiayi City (TW); Chen-Chi Hsiao, Chiayi County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/145,991

(22) Filed: Jun. 7, 2005

(51) Int. Cl. H01H 13/00

(52) U.S. Cl. 200/329

(57) ABSTRACT

A cart includes a frame, a head part, an actuating mechanism, a seat, a front wheel, two rear wheels, and a power switch; the head part is supported on a front end of the frame in an angularly displaceable manner; the seat and the actuating mechanism are supported on the frame; the actuating mechanism includes a motor, and a storage battery set for providing electricity to the motor; the front wheel is connected to a lower end of the head part; the rear wheels are supported on two sides of a rear portion of the frame, and connected to the motor; the power switch includes a hole, and an activating tool; the motor of the actuating mechanism will be powered by the storage battery set after the activating tool is inserted into the hole.

### BACKGROUND OF THE INVENTION

1. Field of the-invention

The present invention relates to a power switch of an actuating mechanism of a cart for use by the elderly and handicapped persons, more particularly one, which is structured in such a way that there can't be accidental or unauthorized activation of the actuating mechanism.

2. Brief Description of the Prior Art

Referring to FIGS. 4 and 5, a conventional three-wheeled cart for use by the elderly and handicapped person includes a frame 91, a head part 92, a seat 93, an actuating mechanism 94, a front wheel 921, two rear wheels 911, and a pivotal switch 95. The head part 92 is supported on a front end of the frame 91 in an angularly displaceable manner. The front wheel 921 is connected to a lower end of the head part 92. The actuating mechanism 94 includes a motor connected to the rear wheels 911, and a storage battery set for providing electricity to the motor. The switch 95 is arranged on an upper side of the head part 92. When the pivotal switch 95 is pivoted to an On position, the actuating mechanism 94 will be activated, and the rear wheels 911 turned by the motor. The motor of the actuating mechanism 94 will stop as soon as the switch 95 is pivoted to an Off position. And, the rider is allowed to control the speed of the cart by means of a control (not shown) on the head part 92.

The switch 95 is easy to use, and suitable for use by the elderly. However, the cart will start to move suddenly, and an elderly rider on the cart is prone to fall down and get injured when the switch is accidentally moved to the On position. In addition, a thief can drive and steal the cart easily because the cart doesn't have any protective device for preventing unauthorized activation of the actuating mechanism. The cart can be locked with a lock to prevent thievery, but it will cause inconvenience. To overcome the above-mentioned problem, a keyhole is formed on the upper side of the head part of the cart, and the actuating mechanism can't be activated unless a correct key is inserted and turned in the keyhole. However, it is somewhat difficult for the elderly, who usually have poor eyesight, to insert the correct key into the keyhole in the correct position.

### SUMMARY OF THE INVENTION

It is a main object of the invention to provide an improvement on a cart for use by handicapped persons and the elderly to overcome the above-mentioned problems. The cart of the invention includes a frame, a head part, an actuating mechanism, a front wheel, two rear wheels, and a power switch. The head part is supported on a front end of the frame in an angularly displaceable manner. The actuating mechanism includes a motor, and a storage battery set for providing electricity to the motor. The front wheel is connected to a lower end of the head part. The rear wheels are supported on two sides of the frame, and connected to the motor. The power switch includes a hole, and an activating tool. After the activating tool is inserted into the hole, the motor will be powered by the storage battery set, and the rear wheels are turned.

### BRIEF DESCRIPTION OF THE DRAWINGS

The present invention will be better understood by referring to the accompanying drawings, wherein:

FIG. 1 is a perspective view of the cart according to the present invention, FIG. 2 is a side view of the cart of the invention, FIG. 3 is a partial perspective view of the cart of the invention, FIG. 4 is a side view of the conventional cart, and FIG. 5 is a partial perspective view of the conventional cart.

### DETAILED DESCRIPTION OF THE PREFERRED EMBODIMENTS

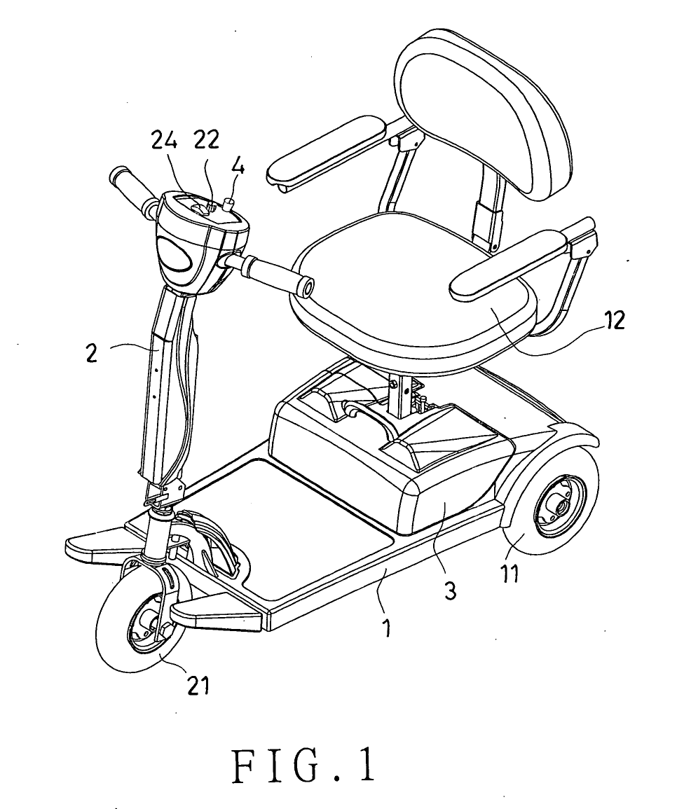

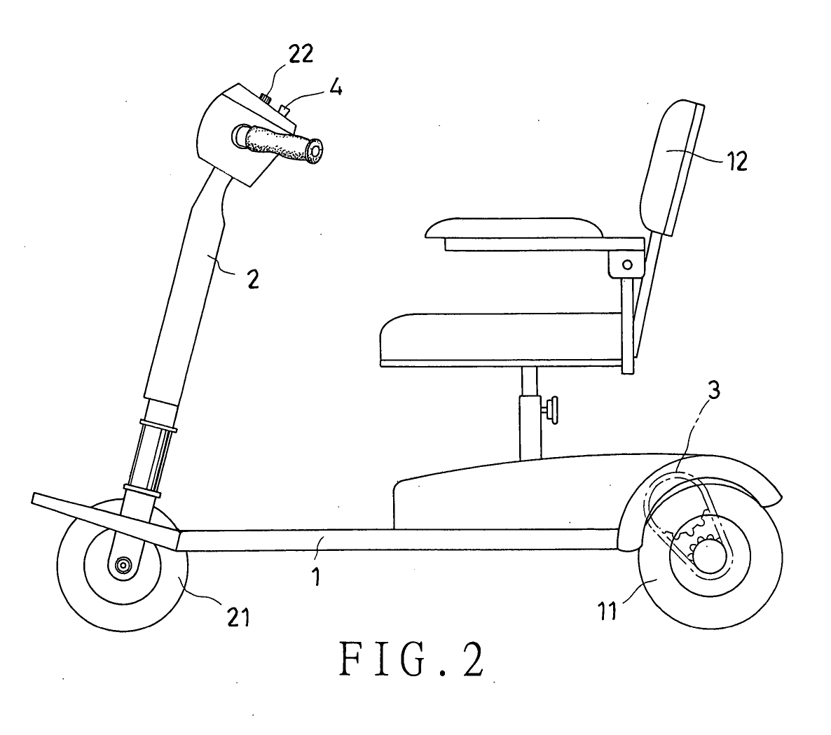

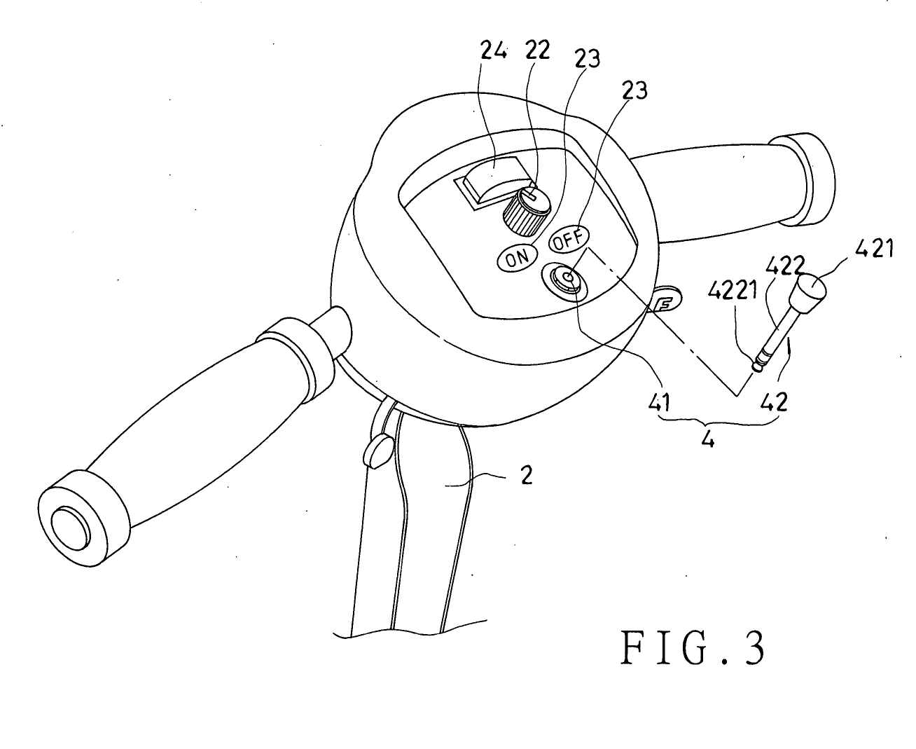

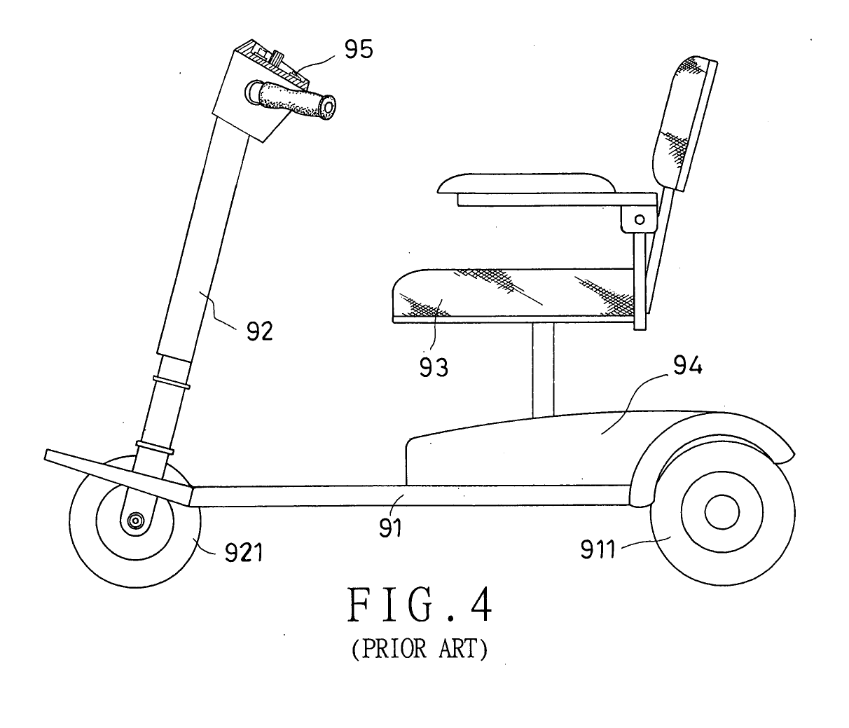

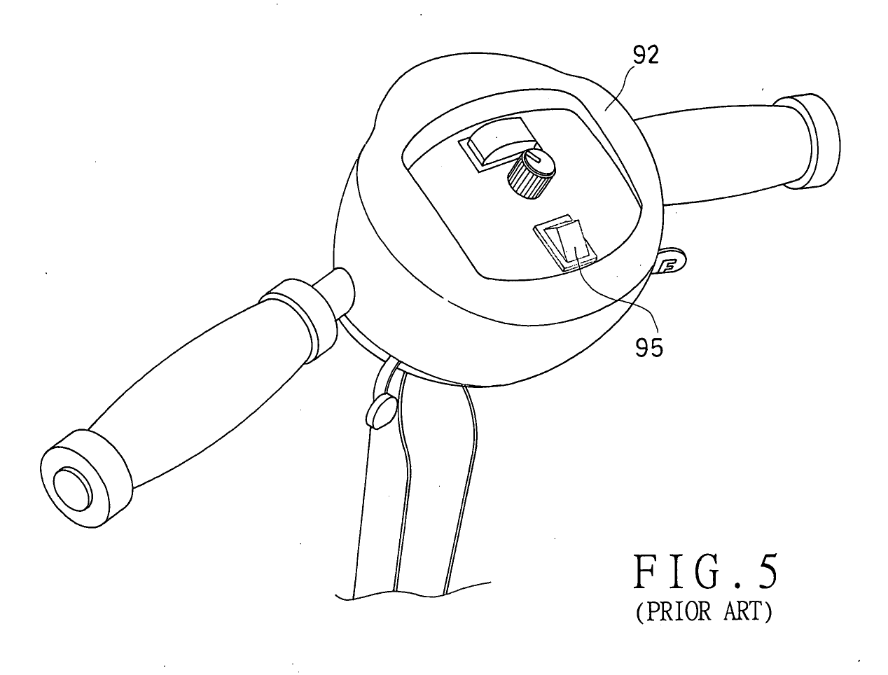

Referring to FIGS. 1 to 3, a preferred embodiment of a cart for use by the elderly and handicapped persons includes a frame 1, a head part 2, an actuating mechanism 3, a power switch 4, a seat 12, a front wheel 21, and two rear wheels 11.

Both the actuating mechanism 3 and the seat 12 are supported on the frame 1. The actuating mechanism 3 includes a motor (not shown), and a storage battery set (not shown) for providing electricity to the motor. The rear wheels 11 are supported on two sides of a rear portion of the frame 1, and connected to the motor of the actuating mechanism 3 such that they will turn when the actuating mechanism 11 is activated. The front wheel 21 is connected to a lower end of the head part 2.

The head part 2 is supported on a front end of the frame - in an-. angularly displaceable manner, and it includes a'control panel, and two handlebars connected to two sides of the control panel. The control panel has a speed regulator 22, On and Off buttons 23, and an electricity meter 24 thereon. The electricity meter 24 is electrically connected to the storage battery set of the actuating mechanism 3 for showing the amount of electricity left in the storage battery set.

The power switch 4 includes a hole 41 formed on the control panel of the head part 2, and an activating tool 42, which is in the shape of a stick, and which has a handle portion 421, an insertion portion 422 having a smaller diameter than the handle portion 421, and a groove 4221 on a tail end of the insertion portion 422. After the insertion portion 422 of the actuating tool 42 is inserted in the hole 41, it will engage, because of the groove 4221 formed thereon, an internal engaging portion of the head part 2 to prevent the actuating tool 42 from falling off the hole 422 accidentally. Alternatively, the hole 422 can be formed on other portions of the cart, e.g. the frame 1.

The motor of the actuating mechanism 3 will be powered by the storage battery set after the activating tool 42 is inserted into the hole 41, and the On button 23 is pressed. The motor won't be powered by the storage battery set when the activating tool 42 is removed from the hole 41 or when the Off button 23 is pressed. And, the rider is allowed to control the speed of the cart by means of using the speed regulator 22. The activating tool 42 can be equipped with an internal circuit or alternatively it can be equipped with a sensor device. The activating tool 42 doesn't have to be turned in the hole 41 in order to activate the actuating mechanism 3 therefore there can't be difficulty for the elderly and the handicapped to use the activating tool 42.

From the above description, it can be easily seen that the present invention has the following advantages:

1. The cart of the present invention can't be driven away without the activating tool therefore thieves can't steal the cart easily. Because the actuating mechanism of the cart of the invention can't be accidentally activated, the present cart is safer to use than the conventional ones only equipped with pivotal switches, which will be activated as soon as the switches are moved to the On position. And, the activating tool is easier to use than conventional keys, suitable for use by the elderly.

2. The cart of the present invention has lower manufacturing cost than other models, and is competitive and suitable for mass production.

What is claimed is:

1. A power switch of an actuating mechanism of a cart for use by the elderly and handicapped persons,
the cart including:
a frame;
a head part supported on a front end of the frame in an angularly displaceable manner;
an actuating mechanism supported on the frame; the actuating mechanism including a motor, and a storage battery set for providing electricity to the motor;
a seat supported on the frame;
a front wheel connected to a lower end of the head part; and
two rear wheels supported on two sides of a rear portion of the frame, and connected to the motor of the actuating mechanism;
the power switch including:
a hole; and
an activating tool; the motor of the actuating mechanism being going to be powered by the storage battery set after the activating tool is inserted into the hole.

2. The power switch as claimed in claim 1, wherein the hole of the power switch is formed on the head part of the cart.

3. The power switch as claimed in claim 1, wherein the hole of the power switch is formed on a suitable portion of the cart.

4. The power switch as claimed in claim 1, wherein the activating tool of the power switch is equipped with a chip.

5. The power switch as claimed in claim 1, wherein the activating tool of the power switch is in a shaped of a stick.

6. The power switch as claimed in claim 1, wherein the activating tool of the power switch has a handle portion, and an insertion portion, which is to be inserted in the hole, and which has a groove thereon; the insertion portion of the actuating tool being going to engage an internal engaging portion of the head part at the groove thereof after it is inserted in the hole.

7. The cart according to claim 1 further having a speed regulator, and On and Off buttons on the head part thereof.

8. The cart according to claim 1 further having an electricity meter on the head part thereof, which is used for showing amount of electricity left in the storage battery set.
